(19) United States
(12) Patent Application Publication
(10) Pub. No.: US 2002/0038325 A1
(43) Pub. Date: Mar. 28, 2002

(54) Method of determining filter coefficients from line spectral frequencies

(76) Inventors: Adrianus Wilhelmus Maria Van Den Enden, Eindhoven (NL); Eric Kathmann, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 09/897,365

(22) Filed: Jul. 2, 2001

(30) Foreign Application Priority Data
Jul. 5, 2000 (EP) 00202382.8

(51) Int. Cl. G06F 17/10

(52) U.S. Cl. 708/300

(57) ABSTRACT

The present invention provides for a method of determining filter coefficients from Line Spectral Frequencies comprising recomputing P(z) and Q(z) polynomials and comprising calculating the ω_{ι}coefficients, characterised by the steps of ordering the polynomials in a series and reducing the number of polynomials in ω_{ι}in the said series by combining the polynomials in ω_{ι}two by two in a manner so as to arrive at two polynomials in ω_{ι}and determining the product of the said two polynomials.

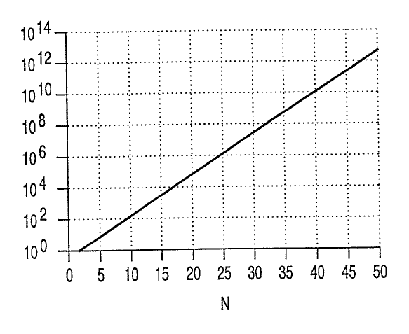

The present invention relates to a method of determining filter coefficients from Line Spectral Frequencies comprising recomputing P(z) and Q(z) polynomials and comprising calculating the ω_{ι}coefficients.

The coding of speech signals is used particularly in the field of mobile communications since the coded speech signal can be transmitted in a manner in which the redundancy commonly experienced in human speech is reduced. Linear Predictive Coding (LPC) is a known technique normally used in speech coding and in which the correlation of the speech signal is removed by means of a filter. The filter is best described by way of one of a different set of parameters, and one important set of which comprises LSFs.

An accurate representation of the filter is an important requirement since such information is transmitted with the speech signal for subsequent reconstruction of the speech signal at a signal-receiving unit.

The advantages of representing LPC filter coefficients in the form of LSFs have been well-documented since the inception of this concept in 1975. As is well known, the representation of an inverse LPC filter A(z) in the form of LSFs is derived from the representation of A(z) by its set of zeros in the z-plane. Insofar as the function A(z) represents an all-zero filter, it can be fully and accurately described by way of reference to its corresponding set of zeros.

Computation of the LSFs commences with the decomposition of the polynomial Aₘ(z) of order m into two inverse polynomial functions P(z) and Q(z). For confirmation, the polynomial Aₘ(z) and the two inverse polynomials appear as follows:

Aₘ(z)=1+a₁z⁻¹+a₂z⁻²+. . .+aₘz^{-m and}

P(z)=Aₘ(z)+z^{-(m+1)}Aₘ(z⁻¹)

Q(z)=Aₘ(z)−z^{-(m+1)}Aₘ(z⁻¹)

The polynomials P(z) and Q(z) each have (m+1) zeros and exhibit various important characteristics. In particular:

all zeros of P(z) and Q(z) are found on the unit circle in the z-plane;

the zeros of P(z) and Q(z) are interlaced on the unit circle and the zeros do not overlap; and

the minimum phase property of Aₘ(z) is easily preserved when the zeros of P(z) and Q(z) are quantised.

Analysis of the above confirms that z=−1 and z=+1 is always zero with the functions P(z) and Q(z) and since these zeros do not contain any information relating to the LPC filter, they can simply be removed from P(z) and Q(z) by dividing by (1+z⁻¹) and (1−z⁻¹).

Such revised functions can be represented when m is even as follows:

$${P}^{′} ( z ) = \frac{P ( z )}{( 1 + {z}^{- 1} )} and {Q}^{′} ( z ) = \frac{Q ( z )}{( 1 - {z}^{- 1} )}$$

and when m is odd as:

P′(z)=P(z) and

$${Q}^{′} ( z ) = \frac{Q ( z )}{( 1 - {z}^{- 1} ) ( 1 + {z}^{- 1} )} .$$

The advantageous properties of functions P(z) and Q(z) as noted above are also valid for P′(z) and Q′(z). Since the coefficients of P′(z) and Q′(z) comprise real numbers, the zeros form complex conjugate pairs such that the search for zeros only has to be conducted on the upper half of the unit circle, i.e. where 0<ω<π.

It generally proves inconvenient to compute complex zeros, particularly by way of computerised numerical analysis methods, and so the functions P′(z) and Q′(z) are transformed to functions P″(z) and Q″(z) with real zeros. Also, the functions P′(z) and Q′(z) always have an even order and, since they are symmetrical, the functions can be re-written with real zeros to the following manner:

$${P}^{″} ( ω ) = 2 {\sum }_{i = 0}^{{m}_{p}} {p}_{i}^{″} cos ( ( {m}_{p} - i ) ω )$$

$${Q}^{″} ( ω ) = 2 {\sum }_{i = 0}^{{m}_{q}} {q}_{i}^{″} cos ( ( {m}_{q} - i ) ω )$$

$$where$$

$${p}_{0}^{″} = 1 , {{p}_{1 , 2 … {m}_{p} - 1}}^{″} = {{p}_{1 , 2 … {m}_{p - 1} }}^{′} , {p}_{{m}_{p}}^{″} = \frac{1}{2} {p}_{m}^{′} , {q}_{0}^{″} = 1 , {q}_{1 , 2 … {m}_{q} - 1}^{″} = {q}_{1 , 2 … {m}_{q} - 1}^{′} ,$$

$${q}_{{m}_{q}}^{″} = \frac{1}{2} {q}_{{m}_{q}}^{′} ,$$

, and where mₚ is equal to the number of zeros of P′(z) on the upper half of the unit circle and where m_{q} is equal to the number of zeros of Q′(z) on the upper half of the unit circle.

When seeking the zeros of these functions, advantage can be taken from the form of the representations for P″(z) and Q″(z) due to the fact that the number of zeros to be located is already known.

Importantly, and of particular relevance to the present invention, once the LSFs have been identified and employed as required, the recomputation of the LPC filter coefficients from the LSFs is required. While this stage represents a much less computationally intensive calculation than the computation of the LSFs from the filter coefficients as discussed above, problems and disadvantageous limitations are experienced. In particular, the values of intermediate coefficients can be disadvantageously high and this can lead to numerical problems even when employing floating point representations.

Recomputing LPC filter coefficients aᵢ from LSFs is much less computationally intensive than computing the LSFs from the filter coefficients. Each LSF ω₁, i=0,1, . . . ,m−1 contributes to a quadratic factor of the form, 1−2cos(ω₁)z⁻¹+z⁻². The polynomials P′(z) and Q′(z) are formed by multiplying these factors using the LSFs that come from the corresponding polynomial:

$${P}^{′} ( z ) = {\prod }_{i = 0}^{{m}_{p} - 1} ( 1 - 2 cos ( {ω}_{2 i} ) {z}^{- 1} + {z}^{- 2} )$$

$${Q}^{′} ( z ) = {\prod }_{i = 1}^{{m}_{q} - 1} ( 1 - 2 cos ( {ω}_{2 i + 1} ) {z}^{- 1} + {z}^{- 2} )$$

The polynomials P(z) and Q(z) are computed by multiplying P′(z) and Q′(z) with the extra zeros at z=−1 and z=+1. Finally, the filter coefficients are computed by using the following equation:

$${A}_{m} ( z ) = \frac{P ( z ) + Q ( z )}{2}$$

which defines the relationship between the polynomial Aₘ(z) and the two inverse polynomials discussed earlier.

Thus, when recomputing the P(z) and Q(z) polynomials one can use the above equations for P′(z) and Q′(z) and add the extra zeros. Thus, for m is even:

$$P ( z ) = ( 1 + {z}^{- 1} ) {\prod }_{i = 0}^{{m}_{p} - 1} ( 1 - 2 cos ( {ω}_{2 i} ) {z}^{- 1} + {z}^{- 2} )$$

$$Q ( z ) = ( 1 - {z}^{- 1} ) {\prod }_{i = 0}^{{m}_{q} - 1} ( 1 - 2 cos ( {ω}_{2 i + 1} ) {z}^{- 1} + {z}^{- 2} )$$

and for m is odd:

$$P ( z ) = {\prod }_{i = 0}^{{m}_{p} - 1} ( 1 - 2 cos ( {ω}_{2 i} ) {z}^{- 1} + {z}^{- 2} )$$

$$Q ( z ) = ( 1 - {z}^{- 1} ) ( 1 + {z}^{- 1} ) {\prod }_{i = 0}^{{m}_{q} - 1} ( 1 - 2 cos ( {ω}_{2 i + 1} ) {z}^{- 1} + {z}^{- 2} )$$

Since ω_{ι}coefficients are ordered in increasing frequency the contributions of the first cos(ω₁) coefficients are positive and the last coefficients are negative. This introduces an undesirable growth of the intermediate coefficient values while conducting the polynomial multiplications (1−2cos(ω_{2ι+1})z⁻¹+z⁻²). With an increasing order of m, such problems are amplified. To illustrate this, an example polynomial Q(z)=1−z^{-2N} has been taken; it being noted that that m=2N. Such a polynomial provides for a system with 2N equidistant zeros on the unit circle. Since this is only a very simple example, it should of course be appreciated that in reality the growth of the intermediate coefficients can be much larger. Therefore a different strategy must be used. It has been found that for high order polynomials m=60 (or N=30) a double precision floating point representation will not be sufficient. A different method might involve searching for the best possible combination of ω_{ι}and which exhibits the least amount of intermediate coefficient growth. However, due to the large number of possible combinations, this is most unlikely to be feasible and it also means that the optimal combination will never be found.

The invention seeks to provide for a method of determining filter coefficients having advantages over known such methods.

In accordance with the present invention there is provided a method of determining filter coefficients from Line Spectral Frequencies as noted above and characterised by the steps of addressing the polynomials in a series and reducing the number of polynomials in ω_{ι}in the said series by combining the polynomials in ω_{ι}two by two in a manner so as to arrive at two polynomials in ω_{ι}and determining the product of the said two polynomials.

The invention serves to combine ω_{ι}in such a way that hardly any signal growth occurs and proves particularly advantageous since the use of an increasing index i would not seem to offer a good solution.

Using the method of the present invention with the example polynomial noted above, i.e. Q(z)=1−z^{-2N}, the intermediate coefficients are never larger than 2. In practice only a limited amount of intermediate coefficient growth occurs. Advantageously, the invention need not comprise a particularly complex method. In general it requires only a different indexing and can advantageously deliver almost optimal results. For P(z) the same procedure could be used only if m is even then P(z) has a root at z=−1. If m is odd P(z) does not have any additional roots, so no additional roots need to be added.

Finally the relationship noted above is employed to compute the coefficients of A(z) from P(z) and Q(z).

The invention is described further hereinafter, by way of example only, with reference to the accompanying drawing which is a graphical representation of the intermediate coefficient growth experienced in the prior art and in an example polynomial Q(z)=1−z^{-2N}.

It is assumed that the original polynomial is reconstructed by combining the zeros with increasing ω₁. The maximum value of the largest coefficient during the recomputation procedure is plotted in the accompanying drawing. Note that the Y axis is logarithmic. For large order N the intermediate values of some of the coefficients become very high.

However, such problems are not encountered in a method according to the present invention.

As an example, and for Q(z) with m is even, the following ordering of the polynomials is used:

v₀[0]=1−z⁻¹

v₀[1]=1−2cosω₁z⁻¹+z⁻²

v₀[2]=1−2cosω₃z⁻¹+z⁻²

v₀[m_{q}]=1−2cosω_{2*m}_{_{q-1}}z⁻¹+z⁻²

If m is odd then the terms for Q(z) are:

v₀[0]=1−z⁻¹

v₀[1]=1−2cosω₁z⁻¹+z⁻²

v₀[m_{q}]=1−2cosω_{2*m}_{_{q-1}}z⁻¹+z⁻²

v₀[m_{q}+1]=1+z⁻¹

The next step is to combine the polynomials v₀[i]. The strategy will be demonstrated with an example with m=12 and m_{q}=6. The original seven polynomials are: v₀[0], v₀[1], v₀[2], v₀[3], v₀[4], v₀[5], and v₀[6].

In the first step the polynomials are combined two by two. Polynomial i is combined with polynomial [m_{q}-i], this gives four intermediate polynomials vᵢ[i]:

v₁[0]=v₀[0]·v₀[6]

v₁[1]=v₀[1]·v₀[5]

v₁[2]=v₀[2]·v₀[4]

v₁[3]=v₀[3]

These four polynomials are combined in the same way, leading to two new polynomials v₂[i]:

v₂[0]=v₁[0]·v₁[3]

v₂[1]=v₁[1]·v₁[2]

The product v₂[0]·v₂[1] gives the final result:

v₃[0]=v₂[0]·v₂[1]

The procedure can formally be described by the following pseudo program:

if m is even

begin

| | |
|---|---|
| m_{q}=m/2 | |
| m_{c}=m_{q}+1 | |
| end | |
| else | |
| begin | |
| m_{q}=(m-1)/2 | |
| m_{c}=m_{q}+2 | |
| end | |
| nₚ=m_{c} | |
| i=mc>>1 | /*arithmetic shift right */ |
| k=0 | |
| while (i>0) | |
| begin | |
| n=0 | |
| while (n<i) | |
| begin | |
| vₖ₊₁[n]=vₖ[n], vₖ[nₚ−n−1] | |
| n=n+1 | |
| end | |
| if nₚ is odd then | |
| begin | |
| vₖ₊₁[n]=vₖ[n] | |
| n=n+1 | |
| end | |
| nₚ=n | |
| k=k+1 | |
| i=n>>1. | /*arithmetic shift right */ |
| end | |

Using this method with the example polynomial Q(z)=1−z^{-2N} the intermediate coefficients are never larger than 2. In practice only a limited amount of intermediate coefficient growth occurs. This is not a very complex method (actually it only uses a different indexing) and delivers almost optimal results. For P(z) the same procedure will be used only if m is even then P(z) has a root at z=−1. If m is odd P(z) does not have any additional roots, so no additional roots need to be added. The last step consists of using the equation

$${A}_{m} ( z ) = \frac{P ( z ) + Q ( z )}{2}$$

to compute the coefficients of A(z) from P(z) and Q(z).

1. A method of determining filter coefficients from Line Spectral Frequencies comprising recomputing P(z) and Q(z) polynomials and comprising calculating the ω₁, coefficients, characterised by the steps of ordering the polynomials in a series and reducing the number of polynomials in ω_{ι}in the said series by combining the polynomials in ω_{ι}two by two in a manner so as to arrive at two polynomials in ω_{ι}and determining the product of the said two polynomials.

2. A method as defined in claim 1, wherein at least one series of intermediate polynomials is formed by combining the original polynomials two by two; the polynomials of the at least one intermediate series also being combined two by two so as to arrive at a yet further reduced number of polynomials.

3. A method as defined in claim 1 or 2, wherein the following ordering of polynomials is used for m is even:
v₀[0]=1−z⁻¹
v₀[1]=1−2cosω₁z⁻¹+z⁻²
v₀[2]=1−2cosω₃z⁻¹+z⁻²
v₀[m_{q}]=1−2cosω_{2*m}_{_{q-1}}z⁻¹+z⁻²

4. A method as defined in claim 1 or 2, wherein the following ordering of polynomials is used for m is odd:
v₀[0]=1−z⁻¹
v₀[1]=1−2cosω₁z⁻¹+z⁻²
v₀[m_{q}]=1−2cosω_{2*m}_{_{q-1}}z⁻¹+z⁻²
v₀[m_{q}+1]=1+z⁻¹

5. An encoder for encoding a source signal, wherein the encoder is arranged for carrying out the method as defined in any one of the preceding claims.

6. A communication device comprising an encoder as defined in claim 5.
